(19) United States
(12) Patent Application Publication
(10) Pub. No.: US 2026/0195804 A1
(43) Pub. Date: Jul. 9, 2026

(54) DESIGN ELEMENT CATEGORY NAVIGATION USER INTERFACE

(71) Applicant: Material Technologies Corporation, New York, NY (US)

(72) Inventors: Joel Rabin, Boca Raton, FL (US); Jerry Mica, Boca Raton, FL (US)

(21) Appl. No.: 19/012,679

(22) Filed: Jan. 7, 2025

(51) Int. Cl. G06Q 30/0601; G06F 3/0482; G06F 9/451

(52) U.S. Cl. CPC G06Q 30/0643; G06F 3/0482; G06F 9/451

(57) ABSTRACT

A design element category navigation user interface and mechanisms to support such an interface involves receiving a request from a user to provide a design element category navigation user interface for a design project. A type of the design project is determined. A number of possible design elements are selected for the design element category navigation user interface based at least on the type of the design project. The number of possible design elements are associated with one or more categories associated with the type of the design project. The design element category navigation user interface is generated using the number of possible design elements and provided to the user.

### FIELD

The described embodiments relate generally to user interfaces. More particularly, the present embodiments relate to design element category navigation user interfaces.

### BACKGROUND

Manufacturers and suppliers of design elements (such as fabrics, floorings, paints, wood, paneling, stone, brick, carpet, laminates, countertops, cabinets, wallpaper, moulding, tiles, housewares, and/or any other kind of material or component that may be used in the design of a space) often present images of their materials for advertising purposes. For example, the design elements may be advertised to potential clients such as designers (e.g., interior designers, exterior designers, and so on) as well as end users (e.g., homeowners, businesses, and so on). Images of the materials may be displayed in print, such as industry magazines, showroom booklets, conference materials, and so on. Images of the materials may also be displayed on a website, such as a manufacturer website, a supplier website, and so on. In some instances, videos including the design elements may be presented. For example, a manufacturer or supplier of a design element may present a promotional video of their design elements to potential clients in a showroom.

Potential clients may use images of design elements as part of a design process related to the design elements, as part of making purchasing and/or other acquisition decisions related to the design elements, and so on. The images may be the most complete information that the potential clients have for making design process decisions related to the design elements, making purchasing and/or other acquisition decisions related to the design elements, and so on. Without sufficient information, it may be challenging for potential clients to make design process decisions related to the design elements, make purchasing and/or other acquisition decisions related to the design elements, and so on.

As an alternative, potential clients may visit locations (such as showrooms, conferences, and so on) where physical samples of design elements are available. For example, potential clients may obtain physical samples of different design elements and place them next to each other to evaluate potential designs that may include the different design elements. Similar to the images discussed above, potential clients may use such physical samples of design elements as part of a design process related to the design elements, as part of making purchasing and/or other acquisition decisions related to the design elements, and so on.

### OVERVIEW

The present disclosure relates to a design element category navigation user interface and mechanisms to support such an interface. A request is received from a user to provide a design element category navigation user interface for a design project. A type of the design project is determined. A number of possible design elements are selected for the design element category navigation user interface based at least on the type of the design project. The number of possible design elements are associated with one or more categories associated with the type of the design project. The design element category navigation user interface is generated using the number of possible design elements and provided to the user.

In various embodiments, a system includes at least one non-transitory storage medium that stores instructions and at least one processor. The at least one processor executes the instructions to receive a request from a user to provide a design element category navigation user interface for a design project; determine a type of the design project; generate an analysis of at least one selected design element that the user has associated with the design project, the at least one selected design element associated with at least one category of a group of categories; select a number of possible design elements for the design element category navigation user interface from a group of design elements based at least on the type of the design project and the analysis, at least one of the possible design elements associated with a different category of the group of categories other than the at least one category; generate the design element category navigation user interface using the number of possible design elements; and provide the design element category navigation user interface for display on at least one display device.

In various examples, the at least one processor further executes the instructions to select the number of possible design elements based at least on a relationship between the number of possible design elements and the at least one selected design element that the user has associated with the design project. In some implementations of such examples, the relationship relates to a color or pattern of the number of possible design elements and the at least one selected design element. In a number of implementations of examples, the relationship is a similarity. In various implementations of examples, the relationship is a contrast. In some implementations of examples, the relationship is that the number of design elements are complementary to the at least one selected design element. In a number of implementations of examples, the relationship is that at least one of the number of possible design elements was purchased by another user who purchased the at least one selected design element. In various implementations of examples, the relationship is based at least on a relationship selection received from the user.

In a number of examples, the user specifies to use the at least one selected design element to generate the design element category navigation user interface. In some examples, an additional one of the possible design elements is associated with the at least one category. In various examples, the at least one processor further executes the instructions to select the number of possible design elements based at least on design elements that are trending. In some examples, the at least one processor further executes the instructions to add at least one of the number of possible design elements to the design project in response to receiving a selection from the user. In a number of examples, the at least one processor further executes the instructions to generate a virtual display of a room including at least one of the at least one selected design element or at least one of the number of possible design elements applied to a surface of the room. In various examples, the at least one processor further executes the instructions to facilitate a purchase of at least one of the number of possible design elements in response to a selection from the user.

In some embodiments, a method includes determining to provide a design element category navigation user interface for a design project using at least one processor; selecting a number of possible design elements for the design element category navigation user interface, using the at least one processor, from a group of design elements based at least on a type of the design project and at least one selected design element that a user has associated with the design project, the at least one selected design element associated with at least one category of a group of categories, at least one of the possible design elements associated with a different category of the group of categories other than the at least one category; generating the design element category navigation user interface, using the at least one processor, using the number of possible design elements; and causing the design element category navigation user interface, using the at least one processor, to be displayed on at least one display device.

In various examples, the method further includes tuning criteria used to select the number of possible design elements; selecting an additional number of possible design elements using the criteria; and generating an updated design element category navigation user interface using the additional number of possible design elements. In some examples, the group of categories includes at least one of ceiling, decking, doors, fac̨ade, fireplace, moulding, trim, paving, landscape, roofing, stairs, elevator, or wall systems.

In a number of embodiments, a computer program product is embodied in at least one tangible computer readable medium. The computer program product includes first instructions stored in the at least one tangible computer readable medium and executable by at least one processor to select a number of possible design elements for a design element category navigation user interface associated with a design project from a group of design elements based at least on a type of the design project and at least one selected design element that a user has associated with the design project, the at least one selected design element associated with at least one category of a group of categories, at least one of the possible design elements associated with a different category of the group of categories other than the at least one category; second instructions stored in the at least one tangible computer readable medium and executable by the at least one processor to generate the design element category navigation user interface using the number of possible design elements; and third instructions stored in the at least one tangible computer readable medium and executable by the at least one processor to cause the design element category navigation user interface to be displayed on at least one display device.

In various examples, the group of categories includes at least one of film, flooring, glass, leather, masonry, stone, metal, paints, paneling, resin, surfaces, textiles, tile, and wallcovering. In some examples, the type of the design project includes at least one of aviation, government, healthcare, hotel, restaurant, industrial, education, marine, medical, dental, mixed-use, multi-unit residential, power and energy, residential, retail, senior living, sports, entertainment, tech, transportation, wellness, or workplace.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example general user interface for interacting with design elements.

FIG. 1B depicts the general user interface upon selection to provide a design element category navigation user interface.

FIG. 1C depicts the design element category navigation user interface of FIG. 1B upon selection to display one or more recommendations from a particular category.

FIG. 2 depicts a flow chart illustrating a first example method for providing a design element category navigation user interface. This method may generate the design element category navigation user interface of FIGS. 1B and/or 1C.

FIG. 3 depicts a flow chart illustrating a second example method for providing a design element category navigation user interface. This method may generate the design element category navigation user interface of FIGS. 1B and/or 1C.

FIG. 4 depicts a flow chart illustrating a third example method for providing a design element category navigation user interface. This method may generate the design element category navigation user interface of FIGS. 1B and/or 1C.

FIG. 5 illustrates an example of a user interface for creating a new design project.

FIG. 6A depicts an design element category navigation user interface that displays one or more recommendations from a particular category and includes a selectable element to tune the provided recommendations.

FIG. 6B displays an example user interface for tuning provided recommendations.

FIG. 7 displays an example user interface for navigating among categories and subcategories of design elements.

FIG. 8 depicts example relationships among example components, one or more of which may be used to provide one or more of the user interfaces of FIGS. 1A-1C, 5-7, perform one or more of the methods of FIGS. 2-4, and/or perform one or more of the techniques discussed herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Designers, construction personnel, architects, contractors, and/or other users of design elements may use one or more user interfaces to search among all the different design elements available by entering one or more search queries to return one or more search results. The designers, construction personnel, architects, contractors, and/or other users of design elements may then use elements of the user interfaces to drill down in the search results using one or more filters, such as the ability to filter by design element material, brand, category (a class or division of design elements regarded as having particular shared characteristics, such as kitchen design elements, bath design elements, tile design elements, carpet design elements, flooring design elements, paint design elements, wall hangings design elements, lighting design elements, tile design elements, textile design elements, paneling design elements, door design elements, leather design elements, metal design elements, decking design elements, roofing design elements, ceiling design elements, and so on), and so on.

However, the sheer number of design elements that may be available for selection by designers, construction personnel, architects, contractors, and/or other users of design elements may be overwhelming from multiple perspectives. For example, it may be extremely difficult and time consuming for designers, construction personnel, architects, contractors, and/or other users of design elements to search among all the different design elements available using existing tools in order to locate the design element or elements that are desired. There may be too many design elements available and/or navigation options among such available design elements to be displayed on existing user interfaces in a way that designers, construction personnel, architects, contractors, and/or other users of design elements can comprehend and navigate among and/or interact with their available choices. Designers, construction personnel, architects, contractors, and/or other users of design elements may give up early and choose less suitable design elements because they cannot spend more time or effort searching due to the sheer number of design elements that may be available for selection, the inability of existing user interfaces or tools to cut through the sheer number of design elements that may be available for selection, the time and effort required for searching among all the design elements that may be available for selection, and so on.

Further, a tremendous amount of hardware and/or software resources may be required to support this kind of searching due to such inadequate user interfaces and/or searching methods. The longer designers, construction personnel, architects, contractors, and/or other users of design elements need to search, the more hardware and/or software resources may be required to interact with the designers and/or other users of design elements. Such interactions may involve usage of hardware and/or software resources for receiving one or more queries, searching among available design materials based on such queries, communicating via one or more networks regarding such queries and/or searching, rendering representations of design elements and/or user interfaces, and so on. The more searching that is required for designers, construction personnel, architects, contractors, and/or other users of design elements to locate desired design elements, the more hardware and/or software resources that may be required to perform such interactions.

Improved user interfaces and mechanisms to support such user interfaces that enable designers, construction personnel, architects, contractors, and/or other users of design elements to more efficiently navigate among and/or interact with available design elements would not only improve the ability of designers, construction personnel, architects, contractors, and/or other users of design elements to find desired design elements and reduce the search time and effort burdens on designers and/or other users of design elements, but they would also reduce the hardware and/or software resources required to support such searching via the user interfaces and mechanisms. Such improved user interfaces and mechanisms to support such user interfaces would be a technical improvement to the technical problem of how to enable designers, construction personnel, architects, contractors, and/or other users of design elements to locate desired design elements among the sheer number of design elements that may be available. Due to the reduced hardware and/or software resources required to support such searching via the user interfaces and mechanisms, these improved user interfaces and mechanisms to support such user interfaces would improve the operation of any computing device used to implement the improved user interfaces and mechanisms to support such user interfaces.

The following disclosure relates to a design element category navigation user interface and mechanisms to support such an interface. A request is received from a user to provide a design element category navigation user interface for a design project. A type of the design project is determined. A number of possible design elements are selected for the design element category navigation user interface based at least on the type of the design project. The number of possible design elements are associated with one or more categories associated with the type of the design project. The design element category navigation user interface is generated using the number of possible design elements and provided to the user.

In various examples, an analysis of at least one selected design element that the user has associated with the design project is performed and the number of possible design elements are further selected based at least on the analysis. For example, the number of possible design elements may be selected when they are similar to the at least one selected design element, complementary to the at least one selected design element, contrasting with the at least one selected design element, and so on. These relationships may be determined using image analysis of design elements, analysis of metadata tags associated with the design elements (which may have been generated using image analysis and/or other mechanisms), and so on. By way of illustration, two design elements may be similar when they include similar colors, include similar patterns, are often used together, are composed of similar materials, have similar uses or applications, and so on. The relationship of the number of possible design elements to the at least one selected design element may be tune-able, such as by the user (such as where the user provides a relationship selection). In some examples, the number of possible design elements may be selected based on previous user behavior (such as design elements the user previously selected in the same design project), trends identified based on current and/or historic other user behavior (such as where design elements have been recently popular with other users in the last month), and so on. Such selections may or may not have a relationship to the at least one selected design element. In some implementations, such selections may be performed using one or more artificial intelligence models trained on data like the previous user behavior, the current and/or historic other user behavior, and so on. Such trained artificial intelligence models may be used to generate one or more recommendations for the number of possible design elements.

The above may result in a manageable amount of design elements presented in the design element category navigation user interface, enabling the user to more efficiently navigate among and/or interact with the various design elements available to the ones the user is most likely interested in without being overwhelmed and without unnecessarily consuming hardware and software resources. The result may be an improved user interface that improves the operation of one or more computing devices involved.

The above may include performance of one or more processes that analyze, filter, compare, and/or the like one or more of the type of the design project, design elements (including the number of possible design elements and the at least one selected design element), and so on in order to perform the above selection, generation, and provision. Such processes may include use of image processing, artificial intelligence and/or machine learning, and so on. By way of illustration, a large number of design elements (such as 100, 1000, 100,000, and so on) may be available to be offered to a user for selection to add to a design project. This may be too many for a user to be able to navigate among efficiently, and may be more than can be shown to a user via a user interface. As such, the large number of design elements may be filtered one or more times down to a more manageable number of design elements (such as 10, 20, 50, and so on). For example, this may be performed by filtering the large number of design elements based at least on those of the large number of design elements that are associated with one or more categories that are associated with a type of the design project and/or have a relationship with a design element selected by the user for the design project (such as the design elements are similar to design element selected by the user for the design project, contrast with the design element selected by the user for the design project, are complementary to the design element selected by the user for the design project) and/or other factors (such as the design elements are currently trending, the user has previously selected the design elements, and so on).

In some examples, the number of design elements include at least one design element associated with at least one category that is associated with the type of the design project but is not associated with the at least one selected design element. This may enable the user to more completely build out the design project by becoming aware of design elements in more categories than if the user was focused on only one or a small number of categories.

In a number of examples, the providing of the design element category navigation user interface may be selected from a more general user interface. The more general user interface may include a number of different mechanisms for exploring design elements, such as a selectable element to provide the design element category navigation user interface. Other user interfaces that may be provided in response to selection of selectable elements in the design element category navigation user interface may include a search selectable element, a mood board selectable element, a virtualization selectable element, a selectable element for providing a user interface for tuning provided recommendations, a selectable element for navigating among categories and subcategories of design elements, and so on. For example, the search selectable element may enable a user to enter one or more search queries (such as by stock keeping unit, key word, and so on) to return one or more search results that may then be drilled down into using one or more filters, such as the ability to filter by design element material, brand, category, and so on. The mood board selectable element may be used to provide a mood board user interface where a user may manipulate and position various selected design elements, make annotations and/or notes, and so on. The virtualization selectable element may be used to apply one or more design elements (such as the number of possible design elements, the at least one selected design element, and so on) to one or more surfaces of a virtual room (such as a selected tile design element to a floor, a selected wallpaper design element to one or more walls, and so on) and then render the virtual room with the applied design elements (whether on a display, projected into a physical space, and so on) to enable the user to see how the design elements would look in use. A user may select various selectable elements of the more general user interface to change between the number of different mechanisms for exploring design elements.

Additional selectable elements may be included. Such additional selectable elements may enable a user to order one or more design materials and/or samples thereof, communicate with one or more providers of one or more design materials, and so on.

Examples of categories may include ceiling, decking, doors, fac̨ade, fireplace, moulding, trim, paving, landscape, roofing, stair, elevator, wall systems, film, flooring, glass, leather, masonry, stone, metal, paints, paneling, resin, surfaces, textiles, tile, wallcovering, and so on. Each design element may be associated with one or more categories.

Examples of the type of the design may include aviation, government, healthcare, hotel, restaurant, industrial, education, marine, medical, dental, mixed-use, multi-unit residential, power and energy, residential, retail, senior living, sports, entertainment, tech, transportation, wellness, workplace, and so on. One or more categories may be associated with each type. For example, medical may be associated with tile, laminate, and lighting categories, but may not be associated with carpet as carpet may not often be used in medical design projects due to the higher difficulty in cleaning carpet that is exposed to medical conditions.

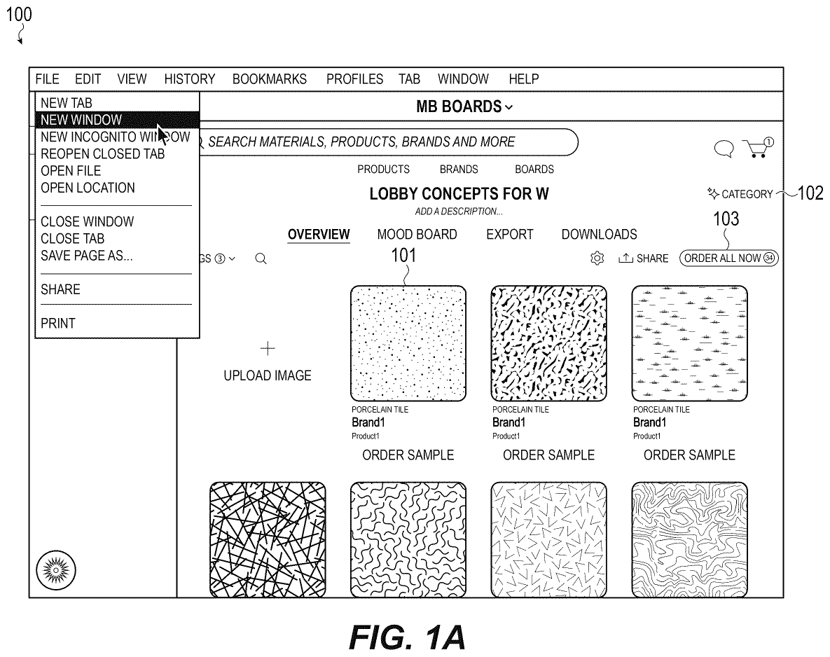

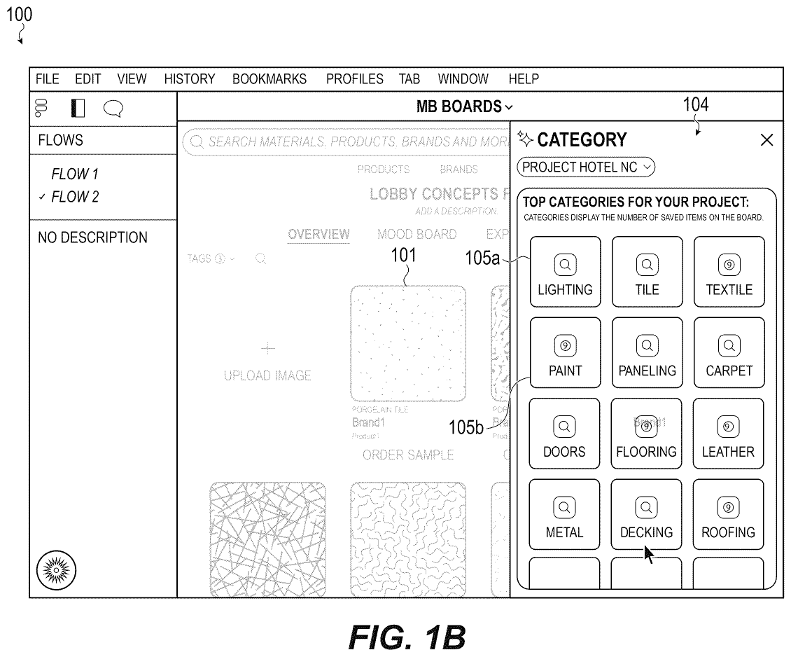

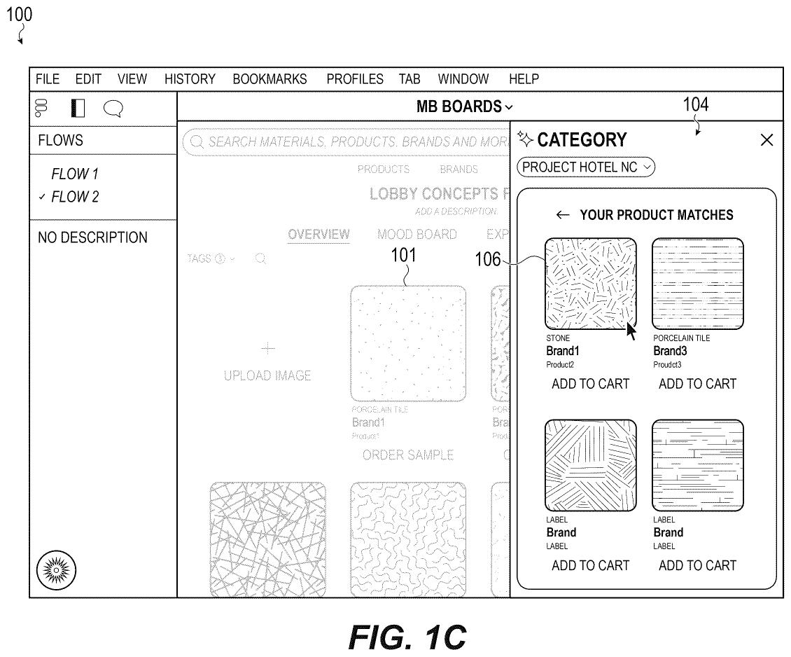

These and other embodiments are discussed below with reference to FIGS. 1A-8 . However, those skilled in the art will readily appreciate that the detailed description given herein with respect to these Figures is for explanatory purposes only and should not be construed as limiting.

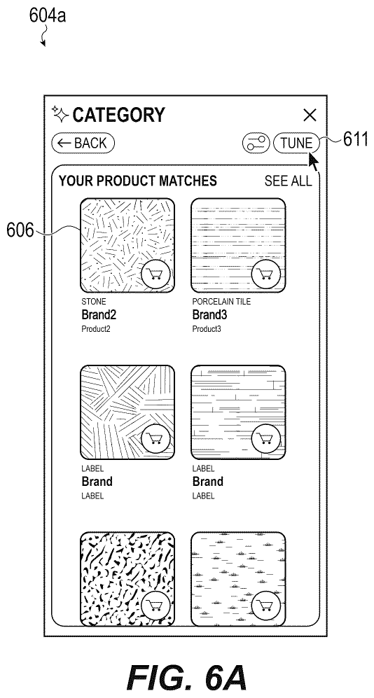

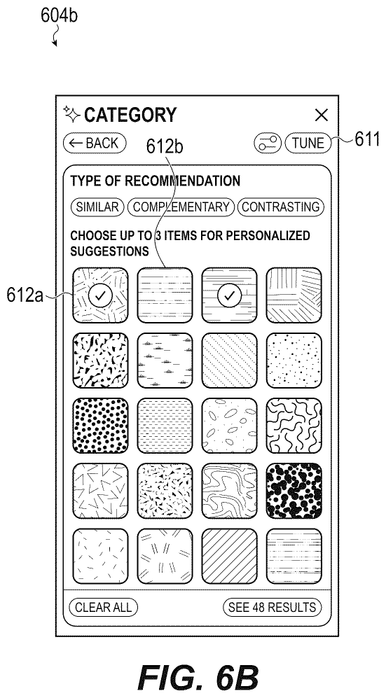

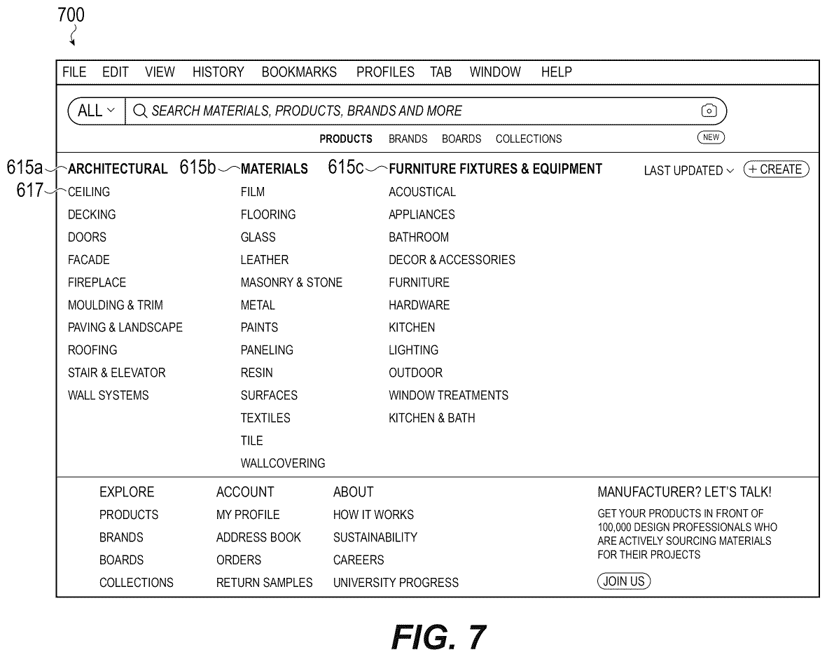

FIG. 1A depicts an example general user interface 100 for interacting with design elements. The general user interface 100 may include a number of different mechanisms for exploring design elements, such as a selectable element 102 to provide the design element category navigation user interface. Other user interfaces that may be provided in response to selection of selectable elements in the design element category navigation user interface may include a search selectable element, a mood board selectable element, a selectable element for providing a user interface for tuning provided recommendations (such as is shown in FIG. 6B), a selectable element for navigating among categories and subcategories of design elements (such as is shown in FIG. 7), a selectable element 103 that enables a user to order one or more design materials and/or samples thereof, and so on.

For example, the search selectable element may enable a user to enter one or more search queries (such as searching by stock keeping unit, key word, and so on) to return one or more search results that may then be drilled down into using one or more filters, such as the ability to filter by design element material, brand, category, and so on. The mood board selectable element may be used to provide a mood board user interface where a user may manipulate and position various selected design elements, make annotations and/or notes, and so on.

A user may select various selectable elements of the more general user interface to change between the number of different mechanisms for exploring design elements.

The general user interface 100 may also include a number of selected design elements, such as a Brand1 selected design element 101. The selected design elements may have been selected by a user using various mechanisms of the general user interface 100.

FIG. 1B depicts the general user interface upon selection to provide a design element category navigation user interface 104. Upon selection to provide a design element category navigation user interface 104, a type of the design project may be determined. The type of the design project may be received from the user, such as when the user first creates the design project. In this example, categories associated with the type of design project may be determined and/or displayed. These categories may include a lighting category 105a and a paint category 105b.

In some implementations, if the user has selected design elements in one of these categories, an image or other graphic element associated with the selected design element may be depicted on the graphical element for the category. In such implementations, a generic icon indicating to search for design elements in the category (such as the magnifying glass shown) may be depicted when the user has not selected design elements in the categories.

FIG. 1C depicts the design element category navigation user interface 104 of FIG. 1B upon selection to display one or more recommendations from a particular category. In this example, the tile category in FIG. 1B may have been selected to cause the change to the current displayed state of the design element category navigation user interface 104. The displayed recommendations include a Brand2 106 design element. The user may be able to select one or more of the recommendations to add the associated design element to the design project.

In various examples, an analysis of at least one of the selected design elements shown in FIG. 1A is performed and the recommendations are further selected based at least on the analysis. For example, the recommendations may be selected when they are similar to the at least one of the selected design elements shown in FIG. 1A, complementary to the at least one of the selected design elements shown in FIG. 1A, contrasting with the at least one of the selected design elements shown in FIG. 1A, and so on. These relationships may be determined using image analysis of design elements, analysis of metadata tags associated with the design elements (which may have been generated using image analysis and/or other mechanisms), and so on. By way of illustration, two design elements may be similar when they include similar colors, include similar patterns, are often used together, have similar applications or uses (such as are both used for indoor use, both are used for outdoor use, and so on), are composed of similar materials, and so on. The relationship of the recommendations to the at least one of the selected design elements shown in FIG. 1A may be tune-able, such as by the user (such as where the user provides a relationship selection, where the user provides one or more specifications like other materials that meet environmental certifications and can be used for x, y, and z purposes, and so on). In some examples, the recommendations may be selected based on previous user behavior (such as design elements the user previously selected in the same design project), trends identified based on current and/or historic other user behavior (such as where design elements have been recently popular with other users in the last month), and so on. Such selections may or may not have a relationship to the at least one of the selected design elements shown in FIG. 1A. In some implementations, such selections may be performed using one or more artificial intelligence models trained on data like the previous user behavior, the current and/or historic other user behavior, and so on. Such trained artificial intelligence models may be used to generate one or more recommendations for the number of possible design elements.

FIGS. 1A-1C are illustrated and described as having a particular configuration. However, it is understood that these are examples. In various implementations, various configurations may be used without departing from the scope of the present disclosure.

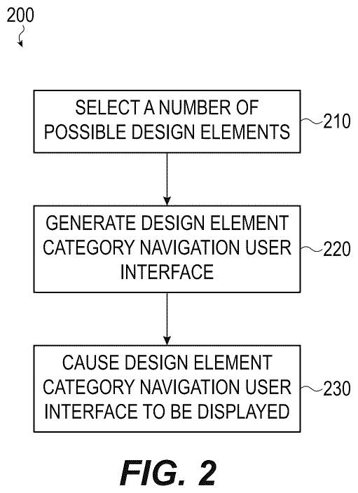

FIG. 2 depicts a flow chart illustrating a first example method 200 for providing a design element category navigation user interface. This method 200 may generate the design element category navigation user interface of FIGS. 1B and/or 1C.

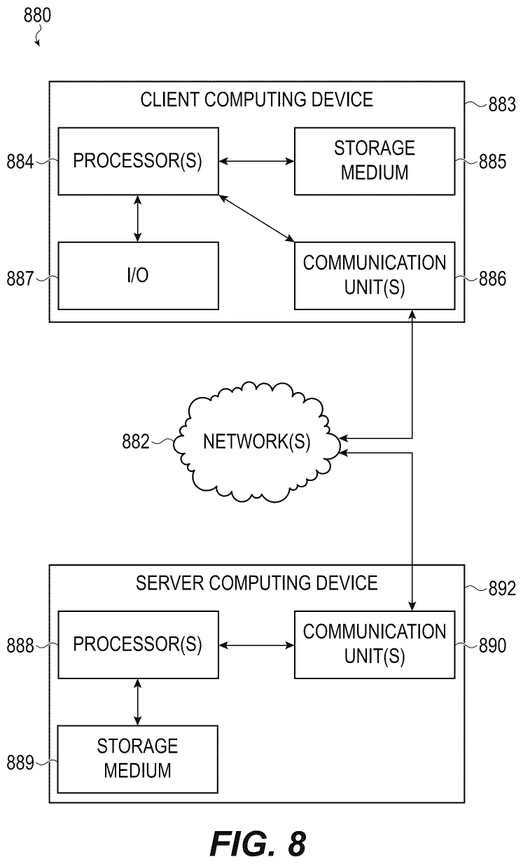

At operation 210, an electronic device (such as the client computing device 883 and/or the server computing device 892 of FIG. 8) may select a number of possible design elements. The design elements may be selected based on association with one or more categories that are also associated with a type of a design project for which the design element category navigation user interface is to be provided, and/or a relationship to (such as similarity to, contrast with, complementary to, and so on) one or more design elements that have already been selected for the design project.

At operation 220, the electronic device may generate the design element category navigation user interface. The design element category navigation user interface may include the number of design elements.

At operation 230, the electronic device may cause the design element category navigation user interface to be displayed. For example, this may include displaying the design element category navigation user interface, transmitting one or more instructions to another electronic device to display the design element category navigation user interface, and so on.

Although the example method 200 is illustrated and described as including particular operations performed in a particular order, it is understood that this is an example. In various implementations, various orders of the same, similar, and/or different operations may be performed without departing from the scope of the present disclosure.

For example, the method is illustrated and described as generating the design element category navigation user interface. However, it is understood that this is an example. In some implementations, the electronic device may generate information for the design element category navigation user interface and then instruct another electronic device to generate the design element category navigation user interface. Various configurations are possible and contemplated without departing from the scope of the present disclosure.

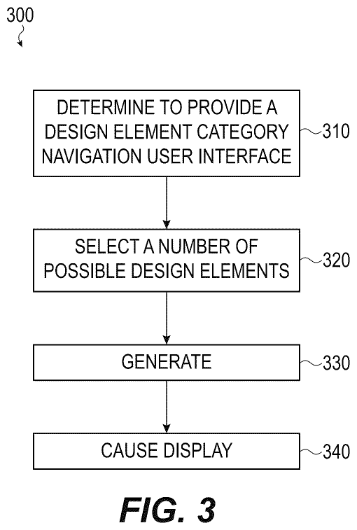

FIG. 3 depicts a flow chart illustrating a second example method 300 for providing a design element category navigation user interface. This method 300 may generate the design element category navigation user interface of FIGS. 1B and/or 1C.

At operation 310, an electronic device (such as the client computing device 883 and/or the server computing device 892 of FIG. 8) may determine to provide a design element category navigation user interface. The electronic device may determine to do so in response to receiving input from a user

At operation 320, the electronic device may select a number of possible design elements. The design elements may be selected based on association with one or more categories that are also associated with a type of a design project for which the design element category navigation user interface is being provided, and/or relationships to (such as similarity to, contrast with, complementary to, and so on) one or more design elements that have already been selected for the design project.

At operation 330, the electronic device may generate the design element category navigation user interface. Generating may involve rendering the design element category navigation user interface, generating information for the design element category navigation user interface, and so on.

At operation 340, the electronic device may cause display of the design element category navigation user interface. Causing display of the design element category navigation user interface may involve providing the design element category navigation user interface to another electronic device.

Although the example method 300 is illustrated and described as including particular operations performed in a particular order, it is understood that this is an example. In various implementations, various orders of the same, similar, and/or different operations may be performed without departing from the scope of the present disclosure.

For example, the method 300 includes operations 310-340. However, it is understood that this is an example. In some implementations, other operations may be included, such as adding at least one of the number of possible design elements to the design project in response to receiving user input via the design element category navigation user interface. Various configurations are possible and contemplated without departing from the scope of the present disclosure.

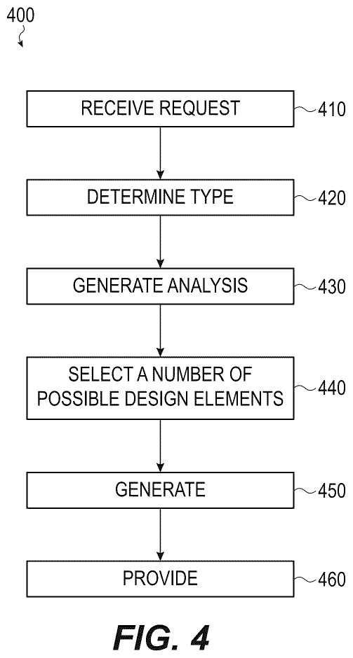

FIG. 4 depicts a flow chart illustrating a third example method 400 for providing a design element category navigation user interface. This method 400 may generate the design element category navigation user interface of FIGS. 1B and/or 1C.

At operation 410, an electronic device (such as the client computing device 883 and/or the server computing device 892 of FIG. 8) may receive a request to provide a design element category navigation user interface. The request may be received from a user via another user interface.

At operation 420, the electronic device may determine a type of a design project for which the design element category navigation user interface is to be provided. The electronic device may determine the type based at least on input from a user, such as when the user first created the design project.

At operation 430, the electronic device may generate an analysis of at least one selected design element that the user has associated with the design project. The analysis may involve analyzing characteristics of the at least one selected design element, such as color, pattern, material, application or use, and so on. The analysis may involve image analysis, artificial intelligence or machine learning analysis, evaluation of metadata, and so on.

At operation 440, the electronic device may select a number of possible design elements. The possible design elements may be selected based on association with one or more categories that are also associated with the type and/or the analysis. For example, the number of design elements may be selected when they are associated with the one or more categories and when they have characteristics that have a relationship with the analysis (such as similarity to, contrast with, complementary to, and so on).

In some examples, the number of design elements are associated with at least one category that is not associated with the at least one selected design element. This may ensure that the number of design elements broadens the categories that have already been considered by the user.

At operation 450, the electronic device may generate information for the design element category navigation user interface, such as by determining what to include in the design element category navigation user interface, how to include the design element category navigation user interface, and so on.

At operation 460, the electronic device may provide the design element category navigation user interface. Providing the design element category navigation user interface may include transmitting the information to another electronic device.

Although the example method 400 is illustrated and described as including particular operations performed in a particular order, it is understood that this is an example. In various implementations, various orders of the same, similar, and/or different operations may be performed without departing from the scope of the present disclosure.

For example, operation 420 is illustrated and described as determining the type. However, it is understood that this is an example. In some implementations, the electronic device may access information indicating the type without performing any kind of determination. Various configurations are possible and contemplated without departing from the scope of the present disclosure.

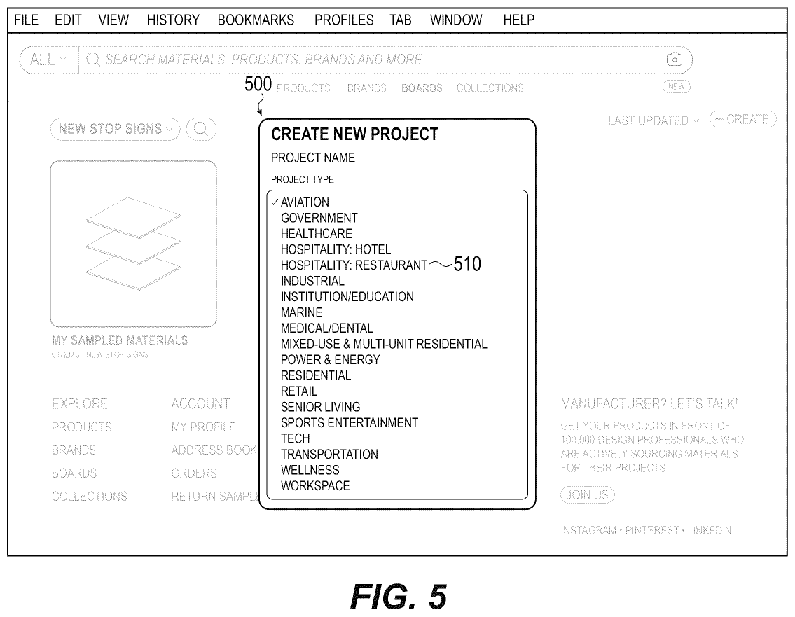

FIG. 5 illustrates an example of a user interface 500 for creating a new design project. As part of creating the new design project, the user may select a type 510 of the project. The type of the design project includes at least one of aviation, government, healthcare, hotel, restaurant, industrial, education, marine, medical, dental, mixed-use, multi-unit residential, power and energy, residential, retail, senior living, sports, entertainment, tech, transportation, wellness, workplace, and so on.

FIG. 6A depicts an design element category navigation user interface 604a that displays one or more recommendations 606 from a particular category and includes a selectable element 611 to tune the provided recommendations.

FIG. 6B displays an example user interface 604b for tuning provided recommendations. The user interface 604b may be presented in response to selection of the selectable element 611. The user interface 604b may include a number of design elements that may be selected to use for recommendations, including a design element 612a that is selected to be used for recommendations and a design element 612b that is not selected to be used for recommendations. The user interface 604b may also include a number of selectable elements for defining the relationship (such as between design elements and one or more selected design elements) to use for recommendations, such as similar, complementary, and so on. A user may use the user interface 604b to tune criteria used to select the number of possible design elements and cause selection of an additional number of possible design elements using the criteria and generation of an updated design element category navigation user interface using the additional number of possible design elements. Various configurations are possible and contemplated without departing from the scope of the present disclosure.

FIG. 7 displays an example user interface 700 for navigating among categories and subcategories of design elements. The user interface 700 may include a number of categories, such as an architectural category 615a, a materials category 615b, and a furniture fixtures & equipment category 615c. The categories may include subcategories, such as a ceiling subcategory 617 that may be a subcategory of the architectural category 615a. A user may select one or more selectable elements of the categories and/or subcategories to navigate among and/or interact with available design elements.

FIG. 8 depicts example relationships 880 among example components, one or more of which may be used to provide one or more of the user interfaces of FIGS. 1A-1C, 5-7, perform one or more of the methods of FIGS. 2-4, and/or perform one or more of the techniques discussed herein.

The relationships 880 include one or more client computing devices 883 operable to communicate with one or more server computing devices 892 via one or more communication networks 882.

The client computing device 883 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The client computing device 883 may include one or more processors 884 and/or other processing units and/or controllers, one or more non-transitory storage media 885 (which may take the form of, but is not limited to, a magnetic storage medium; optical storage medium; magneto-optical storage medium; read only memory; random access memory; erasable programmable memory; flash memory; and so on), one or more communication units 886, input and/or output components 887 (such as one or more keyboards, mice, track pads, touch screens, displays, printers, microphones, graphics cards, and so on), and/or other components. The processor 884 may execute instructions stored in the non-transitory storage medium 885 to perform various functions. Such functions may include receiving user input via the input and/or output components 887, providing output via the input and/or output components 887, communicating with the server computing device 892, and so on. Alternatively and/or additionally, the client computing device 883 may involve one or more memory allocations configured to store at least one executable asset and one or more processor allocations configured to access the one or more memory allocations and execute the at least one executable asset to instantiate one or more processes and/or services, such as one or more rendering services, web services, printing services, ordering services, and so on.

Similarly, server computing device 892 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The server computing device 892 may include one or more processors 888 and/or other processing units and/or controllers, one or more non-transitory storage media 889 (which may take the form of, but is not limited to, a magnetic storage medium; optical storage medium; magneto-optical storage medium; read only memory; random access memory; erasable programmable memory; flash memory; and so on), one or more communication units 890, and/or other components. The processor 888 may execute instructions stored in the non-transitory storage medium 889 to perform various functions. Such functions may include communicating with the client computing device 883, generating one or more user interfaces (such as one or more of those discussed herein) performing one or more methods or processes (such as one or more of those discussed herein), and so on. Alternatively and/or additionally, the server computing device 892 may involve one or more memory allocations configured to store at least one executable asset and one or more processor allocations configured to access the one or more memory allocations and execute the at least one executable asset to instantiate one or more processes and/or services, such as one or more user interface services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, track pads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although FIG. 8 is illustrated and described as including particular components arranged in a particular configuration, it is understood that this is an example. In a number of implementations, various configurations of various components may be used without departing from the scope of the present disclosure.

In various implementations, a system may include at least one non-transitory storage medium that stores instructions and at least one processor. The at least one processor may execute the instructions to receive a request from a user to provide a design element category navigation user interface for a design project; determine a type of the design project; generate an analysis of at least one selected design element that the user has associated with the design project, the at least one selected design element associated with at least one category of a group of categories; select a number of possible design elements for the design element category navigation user interface from a group of design elements based at least on the type of the design project and the analysis, at least one of the possible design elements associated with a different category of the group of categories other than the at least one category; generate the design element category navigation user interface using the number of possible design elements; and provide the design element category navigation user interface for display on at least one display device.

In various examples, the at least one processor may further execute the instructions to select the number of possible design elements based at least on a relationship between the number of possible design elements and the at least one selected design element that the user has associated with the design project. In some such examples, the relationship may relate to a color or pattern of the number of possible design elements and the at least one selected design element. In a number of examples, the relationship may be a similarity. In various examples, the relationship may be a contrast. In some examples, the relationship may be that the number of design elements are complementary to the at least one selected design element. In a number of examples, the relationship may be that at least one of the number of possible design elements was purchased by another user who purchased the at least one selected design element. In various examples, the relationship may be based at least on a relationship selection received from the user. In a number of examples, the user may specify to use the at least one selected design element to generate the design element category navigation user interface. In some examples, an additional one of the possible design elements may be associated with the at least one category. In various examples, the at least one processor may further execute the instructions to select the number of possible design elements based at least on design elements that are trending. In some examples, the at least one processor may further execute the instructions to add at least one of the number of possible design elements to the design project in response to receiving a selection from the user. In a number of examples, the at least one processor may further execute the instructions to generate a virtual display of a room including at least one of the at least one selected design element or at least one of the number of possible design elements applied to a surface of the room. In various examples, the at least one processor may further execute the instructions to facilitate a purchase of at least one of the number of possible design elements in response to a selection from the user.

In some embodiments, a method may include determining to provide a design element category navigation user interface for a design project using at least one processor; selecting a number of possible design elements for the design element category navigation user interface, using the at least one processor, from a group of design elements based at least on a type of the design project and at least one selected design element that a user has associated with the design project, the at least one selected design element associated with at least one category of a group of categories, at least one of the possible design elements associated with a different category of the group of categories other than the at least one category; generating the design element category navigation user interface, using the at least one processor, using the number of possible design elements; and causing the design element category navigation user interface, using the at least one processor, to be displayed on at least one display device.

In various examples, the method may further include tuning criteria used to select the number of possible design elements; selecting an additional number of possible design elements using the criteria; and generating an updated design element category navigation user interface using the additional number of possible design elements. In some examples, the group of categories may include at least one of ceiling, decking, doors, fac̨ade, fireplace, moulding, trim, paving, landscape, roofing, stair, elevator, or wall systems.

In a number of embodiments, a computer program product may be embodied in at least one tangible computer readable medium. The computer program product may include first instructions stored in the at least one tangible computer readable medium and executable by at least one processor to select a number of possible design elements for a design element category navigation user interface associated with a design project from a group of design elements based at least on a type of the design project and at least one selected design element that a user has associated with the design project, the at least one selected design element associated with at least one category of a group of categories, at least one of the possible design elements associated with a different category of the group of categories other than the at least one category; second instructions stored in the at least one tangible computer readable medium and executable by the at least one processor to generate the design element category navigation user interface using the number of possible design elements; and third instructions stored in the at least one tangible computer readable medium and executable by the at least one processor to cause the design element category navigation user interface to be displayed on at least one display device.

In various examples, the group of categories may include at least one of film, flooring, glass, leather, masonry, stone, metal, paints, paneling, resin, surfaces, textiles, tile, and wallcovering. In some examples, the type of the design project may include at least one of aviation, government, healthcare, hotel, restaurant, industrial, education, marine, medical, dental, mixed-use, multi-unit residential, power and energy, residential, retail, senior living, sports, entertainment, tech, transportation, wellness, or workplace.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to a design element category navigation user interface and mechanisms to support such an interface. A request is received from a user to provide a design element category navigation user interface for a design project. A type of the design project is determined. A number of possible design elements are selected for the design element category navigation user interface based at least on the type of the design project. The number of possible design elements are associated with one or more categories associated with the type of the design project. The design element category navigation user interface is generated using the number of possible design elements and provided to the user.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
at least one non-transitory storage medium that stores instructions; and
at least one processor that executes the instructions to:
receive a request from a user to provide a design element category navigation user interface for a design project;
determine a type of the design project;
generate an analysis of at least one selected design element that the user has associated with the design project, the at least one selected design element associated with at least one category of a group of categories;
select a number of possible design elements for the design element category navigation user interface from a group of design elements based at least on the type of the design project and the analysis, at least one of the possible design elements associated with a different category of the group of categories other than the at least one category;
generate the design element category navigation user interface using the number of possible design elements; and
provide the design element category navigation user interface for display on at least one display device.

2. The system of claim 1, wherein the at least one processor further executes the instructions to select the number of possible design elements based at least on a relationship between the number of possible design elements and the at least one selected design element that the user has associated with the design project.

3. The system of claim 2, wherein the relationship relates to a color or pattern of the number of possible design elements and the at least one selected design element.

4. The system of claim 2, wherein the relationship is a similarity.

5. The system of claim 2, wherein the relationship is a contrast.

6. The system of claim 2, wherein the relationship is that the number of design elements are complementary to the at least one selected design element.

7. The system of claim 2, wherein the relationship is that at least one of the number of possible design elements was purchased by another user who purchased the at least one selected design element.

8. The system of claim 2, wherein the relationship is based at least on a relationship selection received from the user.

9. The system of claim 1, wherein the user specifies to use the at least one selected design element to generate the design element category navigation user interface.

10. The system of claim 1, wherein an additional one of the possible design elements is associated with the at least one category.

11. The system of claim 1, wherein the at least one processor further executes the instructions to select the number of possible design elements based at least on design elements that are trending.

12. The system of claim 1, wherein the at least one processor further executes the instructions to add at least one of the number of possible design elements to the design project in response to receiving a selection from the user.

13. The system of claim 1, wherein the at least one processor further executes the instructions to generate a virtual display of a room including at least one of the at least one selected design element or at least one of the number of possible design elements applied to a surface of the room.

14. The system of claim 1, wherein the at least one processor further executes the instructions to facilitate a purchase of at least one of the number of possible design elements in response to a selection from the user.

15. A method, comprising:
determining to provide a design element category navigation user interface for a design project using at least one processor;
selecting a number of possible design elements for the design element category navigation user interface, using the at least one processor, from a group of design elements based at least on a type of the design project and at least one selected design element that a user has associated with the design project, the at least one selected design element associated with at least one category of a group of categories, at least one of the possible design elements associated with a different category of the group of categories other than the at least one category;
generating the design element category navigation user interface, using the at least one processor, using the number of possible design elements; and
causing the design element category navigation user interface, using the at least one processor, to be displayed on at least one display device.

16. The method of claim 15, further comprising:
tuning criteria used to select the number of possible design elements;
selecting an additional number of possible design elements using the criteria; and
generating an updated design element category navigation user interface using the additional number of possible design elements.

17. The method of claim 15, wherein the group of categories includes at least one of ceiling, decking, doors, fac̨ade, fireplace, moulding, trim, paving, landscape, roofing, stair, elevator, or wall systems.

18. A computer program product embodied in at least one tangible computer readable medium, comprising:
first instructions stored in the at least one tangible computer readable medium and executable by at least one processor to select a number of possible design elements for a design element category navigation user interface associated with a design project from a group of design elements based at least on a type of the design project and at least one selected design element that a user has associated with the design project, the at least one selected design element associated with at least one category of a group of categories, at least one of the possible design elements associated with a different category of the group of categories other than the at least one category;
second instructions stored in the at least one tangible computer readable medium and executable by the at least one processor to generate the design element category navigation user interface using the number of possible design elements; and
third instructions stored in the at least one tangible computer readable medium and executable by the at least one processor to cause the design element category navigation user interface to be displayed on at least one display device.

19. The computer program product of claim 18, wherein the group of categories includes at least one of film, flooring, glass, leather, masonry, stone, metal, paints, paneling, resin, surfaces, textiles, tile, and wallcovering.

20. The computer program product of claim 18, wherein the type of the design project includes at least one of aviation, government, healthcare, hotel, restaurant, industrial, education, marine, medical, dental, mixed-use, multi-unit residential, power and energy, residential, retail, senior living, sports, entertainment, tech, transportation, wellness, or workplace.
